(19) United States
(12) Patent Application Publication
(10) Pub. No.: US 2014/0076078 A1
(43) Pub. Date: Mar. 20, 2014

(54) SCREWING SYSTEM HAVING A TOOL HOLDER WHICH CAN BE ACTUATED IN MORE THAN ONE DIRECTION

(71) Applicant: Robert Bosch GmbH, (US)

(72) Inventor: Michael Vollmuth, Muehlheim (DE)

(73) Assignee: Robert Bosch GmbH, Stuttgart (DE)

(21) Appl. No.: 13/785,664

(22) Filed: Mar. 5, 2013

(30) Foreign Application Priority Data
Mar. 7, 2012 (DE) 10 2012 004 358.9

(51) Int. Cl. F16H 19/02

(52) U.S. Cl. CPC F16H 19/02
USPC 74/22 R

(57) ABSTRACT

A screwing system, in particular for assembly plants, includes a drive shaft, which is rotatable with respect to its longitudinal axis, and an output shaft, which is rotatable with respect to its longitudinal axis. The rotary motion of the output shaft is coupled via a coupling device with the rotary motion of the drive shaft. The output shaft has a tool holder configured to receive a tool. The output shaft is movable in relation to the drive shaft along its longitudinal direction in two opposite directions, and a drive device, which moves the output shaft at least in one of these directions, is provided.

This application claims priority under 35 U.S.C. §119 to patent application no. DE 10 2012 004 358.9, filed on Mar. 7, 2012 in Germany, the disclosure of which is incorporated herein by reference in its entirety.

### BACKGROUND

The present disclosure relates to a screwing system. In particular, the disclosure relates to a screwing system which can be used in automatic and semiautomatic assembly plants. Screwing systems of this type have long been known from the prior art. Such screwing systems usually have screw spindles or multispindles, which are usually fastened on a mounting plate.

This mounting plate must usually always be moved toward the screwing point and away from it. This requires a mechanical drive and precise guide elements in order that the screwing points can be hit. A further drawback of such systems consists in a relatively high configuration complexity for the adjustment of the mounting plates. Thus, in the case of adjustable pitch circles, for example, individual spindles can be advanced only by means of additional mechanical complexity. This applies, for example, to wheel nut removers for four-hole and five-hole rims.

The object of the present disclosure is therefore to economize on configuration costs and, in addition, also preferably to reduce material, spatial requirement, weight and/or the mass moment of inertia. A further object of the present disclosure consists in providing a facility for improved torque measurement.

The disclosure is described with reference to screwing systems which are also particularly suitable for the present disclosure, since there are generally no high radial forces acting on the screwing tool. In addition, it would also be possible, however, to apply the disclosure to other tools, such as, for instance, to drilling tools or grinding tools.

These objects are achieved according to the disclosure by a screwing system according to the description below. Advantageous embodiments and refinements are the subject of further description below.

### SUMMARY

In a screwing system which serves, in particular, for assembly plants, there is provided a drive shaft, which is rotatable with respect to its longitudinal axis, and an output shaft, which is rotatable with respect to its longitudinal axis and the rotary motion of which is coupled via a coupling device with the rotary motion of the drive shaft. The output shaft here has a tool holder for the reception of a tool.

According to the disclosure, the output shaft is movable in relation to the drive shaft along its longitudinal direction in two opposite directions, and a drive device, which moves the output shaft at least in one of these directions, is additionally provided.

Advantageously, the first direction is constituted by a direction with which the tool head or the tool holder can be advanced to a tool. In the other direction, the tool holder or a tool is removed from the workpiece. Advantageously, the tool is exchangeably arranged on the tool holder.

According to the disclosure, it is therefore proposed that an output shaft is configured such that it is additionally movable in its longitudinal direction in relation to its drive shaft in order thereby to avoid the movable mounting plates, provided in the prior art, on which the screw spindles are disposed in their entirety. In contrast to the prior art, the entire screw spindle or multispindle must therefore now no longer be moved, but rather only a relatively small and light component part of the same. Also no specific guide element is necessary for the screw spindle itself, since the position thereof can be maintained.

Advantageously, the screwing system has a drive device for generating a rotary motion of the drive shaft (which can also be referred to as an elongated drive element) and this drive device is arranged such that it is preferably stationary in the longitudinal direction. It is here possible for the drive device to be arranged at least indirectly on a stationary support. Advantageously, the drive device is constituted by an electric drive device. In addition, however, a pneumatic or hydraulic drive device could be used.

Advantageously, the coupling device is configured such that no movement of the output shaft in relation to the drive shaft in a direction perpendicular to the longitudinal direction is possible.

In a further advantageous embodiment, the coupling device has a first toothing disposed on the drive shaft and a second toothing disposed on the output shaft, which toothings intermesh. A circumferential toothing can here be constituted, for instance, by a cog-like toothing. It would also be possible, however, for just a partial toothing to be provided in the circumferential direction. It would also be possible for the output shaft and the drive shaft to engage in one another such that, although a relative movement in the longitudinal direction is possible, the rotation of the output shaft is nevertheless coupled to a rotation of the drive shaft. Tongue and groove systems, for instance, would thus be conceivable by arranging on the drive shaft a projection extending in the longitudinal direction thereof, which projection engages in a recess or groove disposed on the output shaft.

Advantageously, a longitudinal direction of the output shaft and a longitudinal direction of the drive shaft geometrically coincide. It would also be possible, however, for the longitudinal direction of the output shaft to be offset in parallel from the longitudinal direction of the drive shaft.

In a further advantageous embodiment, at least one of said toothings extends in the longitudinal direction. The effect is that a mutual engagement or a rotationally secure coupling between the drive shaft and the output shaft is maintained irrespective of a relative position of the output shaft in relation to the drive shaft.

In a further advantageous embodiment, the toothing disposed on the drive shaft is an external toothing and the toothing disposed on the output shaft is an internal toothing. Preferably, the output shaft can here surround the drive shaft. The output shaft can thus, for example, have a receiving cavity, into which the drive shaft can be introduced. In a further advantageous embodiment, the drive shaft is fixed in its longitudinal direction. Advantageously, the drive shaft is also fixed in a direction perpendicular to the longitudinal direction and, particularly preferably, is therefore merely rotatable. Advantageously, the output shaft (at least in sections and preferably in sections) is configured as a hollow shaft.

In a further advantageous embodiment, the drive device is a fluid-actuated drive device and, particularly preferably, a pneumatic drive device. Instead, a hydraulic drive device, a magnetic drive device, an electromotive drive device or the like would also however be possible. The drive device could also be constituted by a manually actuable element. Preferably, a spindle bearing having a tool holder which is here pneumatically actuable in both directions is therefore proposed.

In a further advantageous embodiment, a piston element, which is movable in relation to a housing in said longitudinal direction, is disposed on the output shaft. Advantageously, this housing here surrounds said piston element. Furthermore, the housing is preferably also suitable for the reception of a pneumatic medium or a hydraulic medium.

Advantageously, the piston element is constituted by a piston ring, which is arranged such that it seals with respect to the housing. Advantageously, the housing is itself arranged stationary. In a further advantageous embodiment, the piston element is configured as a piston ring, which particularly preferably is fixedly disposed on the output shaft and which particularly preferably is arranged such that it seals with respect to the housing.

Advantageously, the piston element is arranged in said longitudinal direction constantly between the two connections for the pneumatic or hydraulic medium. Two pneumatic or hydraulic chambers, separated by the piston element, are thus advantageously configured within the housing.

In a further advantageous embodiment, a first sealing device is provided to seal the output shaft with respect to the housing. In this way, the escape of pneumatic or hydraulic medium from the housing can be prevented, or at least reduced. In addition, a further sealing device is advantageously provided, which sealing device prevents a pneumatic or hydraulic medium from flowing from one pneumatic chamber within the housing to the other pneumatic chamber within the housing.

In a further advantageous embodiment, the drive shaft is disposed via a spindle drive on a drive spindle. This drive spindle can here be arranged stationary. A support, on which one or more drive devices or drive spindles are disposed, can here be provided.

In a further advantageous embodiment, the screwing system has a spring element, which pretensions the output shaft in relation to the drive shaft in one of said motional directions. In this embodiment, said drive device must merely create the movement in one direction and the movement in the other direction is achieved by the spring element.

In other words, an additionally installed spring is here advantageously provided, which spring actuates the output shaft in one direction, i.e. the output shaft is actuated by means of the spring force in one direction, so that, for the movement in this direction, no compressed air or no hydraulic medium is any longer necessary. In this embodiment, it is conceivable for the spring element to fulfill the traditional function of a spindle bearing and for the pneumatics, in particular the compressed air, to then be used only to retract the spindle bearing. Advantageously, the spring element forces the drive shaft and the output shaft apart in the longitudinal direction. This means that, through the effect of the spring element, the output shaft is preferably advanced to the tool. In the event of failure of the pneumatic drive, the tool is thereby brought, in particular, into a working position.

In a further advantageous embodiment, at least one locking element, which locks the output shaft in relation to the drive shaft in the longitudinal direction, is provided. In particular, this locking means here serves to lock the output shaft in relation to the drive shaft in a working position of the screwing system.

In a further advantageous embodiment, the screwing system has a plurality of output shafts, the longitudinal directions of which extend, particularly preferably, parallel to one another. Preferably, these individual output shafts are also displaceable in their longitudinal direction in relation to drive shafts respectively assigned thereto. A drive device can here serve to in this way displace all output shafts in relation to the drive shafts respectively assigned thereto. In addition, it would also be possible, however, for a plurality of drive devices to be provided.

Advantageously, the screwing system has a measuring device, in order to measure a physical parameter which is characteristic of the screwing operation. Advantageously, the measuring device is constituted by a torque measuring device. This torque measuring device can here be configured such that it measures a torque which arises between the drive shaft and the output shaft.

### BRIEF DESCRIPTION OF THE DRAWINGS

Further advantages and embodiments emerge from the appended representations, wherein:

FIG. 1 shows a screwing system according to the prior art;

FIG. 2 shows a screwing system in a first embodiment; and

FIG. 3 shows a screwing system in a second embodiment.

### DETAILED DESCRIPTION

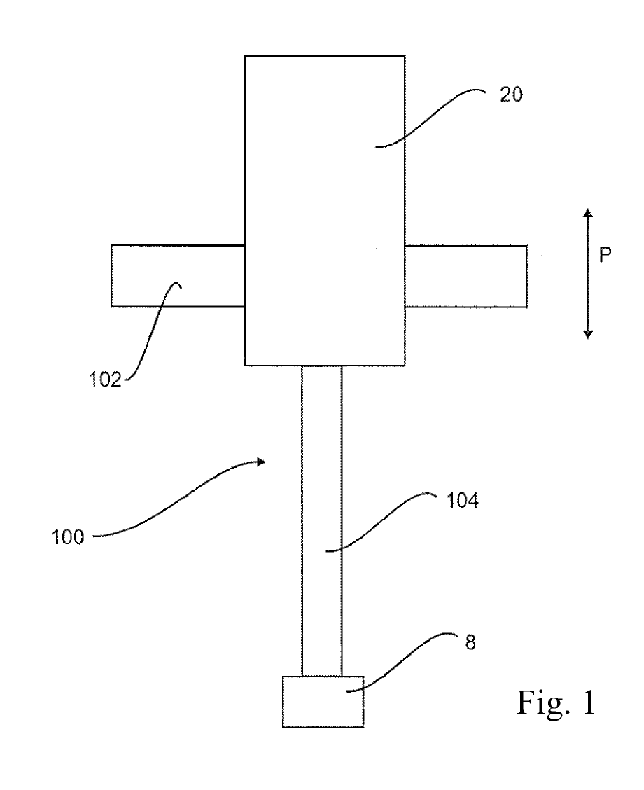

FIG. 1 shows a screwing system 100 according to the prior art. A drive 20, mounted on a mounting plate 102, is herein provided. This drive 20 drives an output shaft 104, on which a tool 8 is disposed. The drive 20 is movable jointly with the mounting plate 102 in the direction of the double arrow P, for example in order to change a tool. Very high forces must hereby be applied in order to move the drive 20.

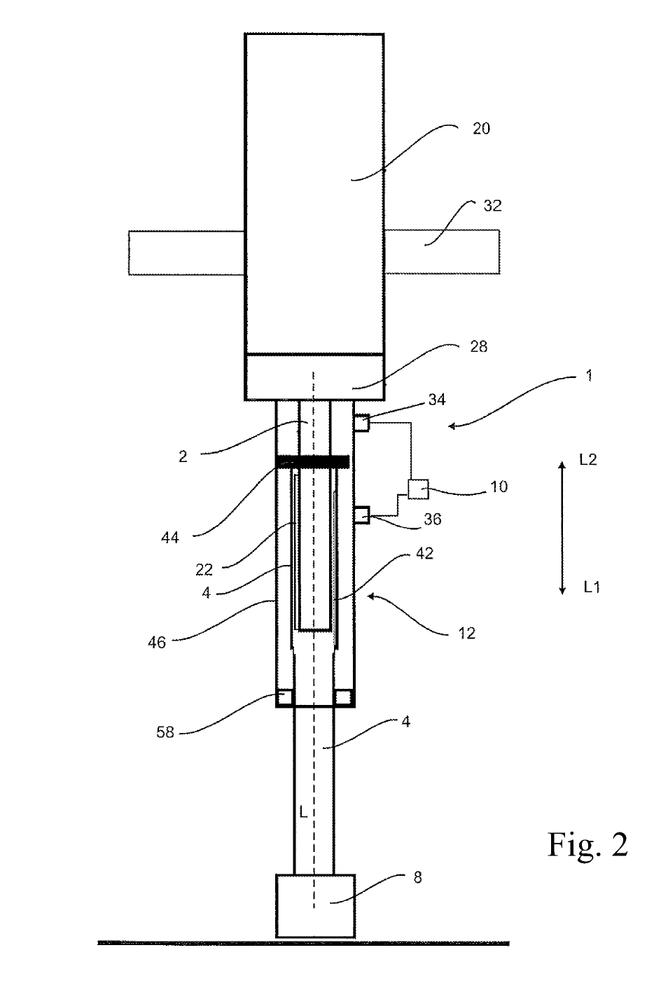

FIG. 2 shows a screwing system 1 in a first embodiment. Here too, a spindle drive 20 is once again provided, which spindle drive is disposed on a mounting plate 32 or, in general terms, on a support 32. In this embodiment, this support 32, or else the spindle drive 20, is arranged stationary. The spindle drive 20 drives a drive shaft 2 for rotation with respect to a longitudinal axis L (which thus also acts as a rotational axis). For this purpose, this drive shaft can be flange-mounted on the spindle drive 20. The drive shaft 2 here has an external toothing 22 (represented only schematically), which engages in a (likewise only partially represented) internal toothing 42 of an output shaft 4. In this way, the rotary motion of the drive shaft 2 can be transmitted to the output shaft 4. Furthermore, the output shaft 4 is movable in relation to the drive shaft 2 in the two directions L1 and L2. A lifting motion of the whole of the spindle drive 20 can hereby be dispensed with.

Reference symbol 10 denotes a drive device which effects the relative movement of the output shaft 4 in relation to the drive shaft 2 in the two directions L2 and L1. The drive device 10 is here constituted by a pneumatic drive, which via two pneumatic connections 34, 36 can feed a pneumatic medium to a housing 46. A piston element 44 can be moved by this pneumatic medium in the directions L1 and L2 and, with it, the output shaft 4 disposed on the piston element 44. Reference symbol 8 relates to a tool holder, on which a tool (not shown) can be disposed.

The housing 46 is thus arranged in a rotationally secure manner and the output shaft 4 is sealed with respect to the housing 46 by means of sealing devices 58. It is possible, in this case, for a certain small quantity of pneumatic medium to escape here. Care should be taken to ensure, however, that the pressure which can be delivered via the connection 36 is in any event sufficiently high to allow the piston element 44 to be moved jointly with the output shaft 4 in the direction L2, i.e. upward.

Reference symbol 12 denotes in its entirety the coupling device which couples the rotary motion of the output shaft 4 to the rotary motion of the drive shaft 2, yet at the same time permits a relative movement of the output shaft 4 in relation to the drive shaft 2 in the directions L1 and L2. This coupling device 12 is here formed by the two toothings 22 and 42, though, as stated above, other types of coupling too would be possible. It would also be possible for the drive shaft to have a cross section which varies from a circular cross section (for instance a polygonal cross section or an elliptical cross section), and also for the output shaft 4 to have a cavity having a cross section tailored thereto, so that no relative rotation between the drive shaft 2 and the output shaft 4 is possible.

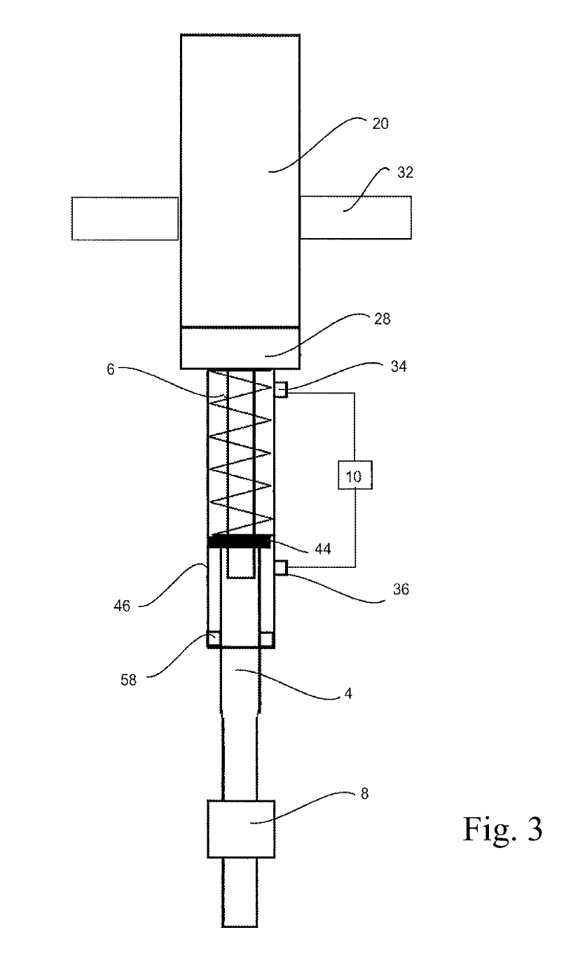

FIG. 3 shows a further embodiment of a screwing system. Here a housing is likewise again provided, as well as also a drive shaft 2 and an output shaft 4. Additionally, however, a spring element 6, with the aid of which the output shaft 4 is here forced downward, i.e. away from the drive shaft 2, is also here provided. The piston element 44 too is sealed by means of sealing devices (not shown) with respect to the housing 46 or the inner wall of the housing 46. In this embodiment, a tool 8a can also be seen, which tool is here disposed on the tool holder 8. Reference symbol 28 denotes a flange-like drive for the drive shaft 2.

In the embodiment shown in FIG. 3, the spring element 6 is disposed above the piston element 44 or between the piston element and the drive. It would also be possible, however, to dispose the spring element beneath the piston element 44 or between the piston element 44 and the tool holder 8. In this case, the spring element would draw together the output shaft 4 and the drive shaft 2. It would also be possible for the spring element to be configured such that it contracts and thereby effects the relative movement between the drive shaft 2 and the output shaft.

If such a spring element is provided, it would also be possible to dispense with the two pneumatic connections 34, 36. It would also be possible to dispense with the spring element and nevertheless provide just one connection for the pneumatic medium. In this case, the extension motion of the output shaft 4 or the advancement to the workpiece could be realized under the effect of gravity. In this case, the lower pneumatic connection could be opened and the pneumatic medium could escape and the piston element could move correspondingly downward. The drive device 10 would here effect only the movement of the output shaft in the direction L2.

The Applicant reserves the right to claim all features disclosed in the application documents as fundamental to the disclosure, insofar as they, individually or in combination, are novel in relation to the prior art.

What is claimed is:

1. A screwing system, comprising:
a drive shaft rotatable with respect to a drive shaft longitudinal axis;
an output shaft rotatable with respect to an output shaft longitudinal axis; and
a drive device, wherein:
rotary motion of the output shaft is coupled via a coupling device with rotary motion of the drive shaft,
the output shaft has a tool holder configured to receive a tool,
the output shaft is movable in relation to the drive shaft along the output shaft longitudinal direction in two opposite directions, and
the drive device is configured to move the output shaft in at least one of the two opposite directions.

2. The screwing system according to claim 1, wherein:
the coupling device has a first toothing disposed on the drive shaft and a second toothing disposed on the output shaft, and
the first toothing and the second toothing are configured to intermesh.

3. The screwing system according to claim 2, wherein at least one of the first toothing and the second toothing is configured to extend in a longitudinal direction.

4. The screwing system according to claim 2, wherein the first toothing is an external toothing and the second toothing is an internal toothing.

5. The screwing system according to claim 1, wherein the drive device is a pneumatic drive device.

6. The screwing system according to claim 1, further comprising:
a piston element movable in relation to a housing in a longitudinal direction, the piston element disposed on the output shaft.

7. The screwing system according to claim 6, further comprising:
a sealing device configured to seal the output shaft with respect to the housing.

8. The screwing system according to claim 1, wherein the drive shaft is disposed via a spindle drive on a drive spindle.

9. The screwing system according to claim 1, further comprising:
a spring element configured to pretension the output shaft in relation to the drive shaft in one of the two opposite directions.

10. The screwing system according to claim 9, wherein the spring element is configured to force the drive shaft and the output shaft apart in one of the two opposite directions.
